(19) United States
(12) Patent Application Publication
(10) Pub. No.: US 2005/0147726 A1
(43) Pub. Date: Jul. 7, 2005

(54) Noodle product including vegetables-containing teabag and oil-excluding fumigated noodle, and package for noodle and soup

(76) Inventor: Hyung-Tae Lim, Seoul (KR)

Correspondence Address: Joseph Hyosuk Kim;JHK Law, PO Box 1078, La Canada, CA, 91012-1078, US

(21) Appl. No.: 10/509,666

(22) PCT Filed: Mar. 31, 2003
(86) PCT No.: PCT/KR03/00645

(30) Foreign Application Priority Data
Mar. 30, 2002 (KR) 10 2002 0017662
Mar. 30, 2002 (KR) 20 2002 0009626
Mar. 29, 2003 (KR) 20 2003 0009537

(51) Int. Cl. A23L 1/00

(52) U.S. Cl. 426/557

(57) ABSTRACT

Disclosed is a noodle product including a teabag charged with powders, pellets of flakes of radish juice, bean sprout juice, green tea leaves, large green onion, green chili pepper, dried fragrant mushroom, sea tangle, garlic, onion and/or dried pollack shreds, and an oil-free, flavor-infused noodle. A package for noodle and soup base is also provided, having at least two of noodle or soup base-packaging parts for control of a using amount of the soup base and the noodle according to likes and dislikes of consumers.

### TECHNICAL FIELD

The present invention relates to noodle products and packages for noodles and soup bases.

More specifically, the present invention relates to an instant-cooking noodle product comprising a teabag type soup base for use in providing vegetable broth and an oil-free noodle infused with various flavors.

In addition, the present invention relates to a package for soup base allowing users to use all or parts of the soup base contained separately in a plurality of packaging parts, according to likes and dislikes of individual consumers.

Further, the present invention relates to a package for noodles allowing users to use all of parts of the noodles contained separately in a plurality of separated or connected packaging parts, according to likes and dislikes of consumers.

### BACKGROUND ART

Nowadays, instant noodles have been increasingly consumed, and there have been commercialized various kinds of the noodles. Variety of the noodles depends on noodle textures and soup flavors. In general, the noodle is prepared by the processes of blending noodle materials, forming the blended noodle materials into sheets, cutting the sheets to make noodle strands, and shaping, steaming, frying and cooling the noodle strands. Conventional techniques related to instant noodles include a method of preparing an instant noodle disclosed in Korean Patent Laid-open Publication Nos. 86-6214, 86-5597, 87-264 and 89-9297, and a method of preparing a noodle snack and a method of preparing a noodle confectionery disclosed in Korean Patent Laid-open Publication Nos. 2001-29100 and 2001-9344, respectively.

Many people enjoy eating instant noodles, regardless of their ages. Consumers' preferences for types of instant noodles vary widely, too. Thus, there is continuously required development of instant noodles having various tastes, to meet a variety of demands of consumers.

A commercially available noodle product is composed of a noodle-containing package and a soup base enclosed in the package. As shown in FIG. 1, such a package includes a wrapper 1 made of a synthetic resin, which is charged with a predetermined amount of soup base or noodles. In the wrapper 1, the soup base in the form of powder, liquid or dried flakes may be contained, or the noodle in the solid or semi-solid state may be contained.

The packaged noodle is introduced into boiling water and cooked for a regular time, after which a soup base is added to the cooked noodle. Or, the soup base may be added together with the noodle, upon cooking the noodle.

However, a conventional instant-cooking noodle product is disadvantageous in terms of a fixed amount of the soup base contained in the package. Thus, it is difficult to control the added amount of the soup base, according to likes and dislikes of consumers.

For example, for consumers disliking spicy foods, the extra soup base remaining after adding a portion of soup base is discarded, or such a soup base is additionally stored for later use. As such, storage of the remaining soup base becomes very involved. Meanwhile, for consumers liking spicy foods, a dressing material is further used after the total packaged soup base is added.

In case of the noodle, since the noodle is contained in a fixed amount in a conventional package, the amount of the noodle is difficult to control according to likes and dislikes of consumers.

In this regard, for consumers having small appetites, parts of the noodles are cooked and the remaining noodles are additionally stored for later cooking. In such a case, it is difficult to store the remaining noodles. Moreover, after a predetermined period of time, air and moisture are penetrated into the package containing the remaining noodles, whereby the noodles become wet and are spoiled. Thus, conventional packages for noodles suffer from difficult storage thereof.

Further, a conventional package for noodle is a single packaging type containing a noodle and a soup base together, and thus may be easily broken upon transporting and storing thereof. Also, such a package is made of a synthetic resin, such as polyethylene or polypropylene, which has a cheap and inferior appearance.

Although the above package has uneven parts la formed at both ends of the wrapper 1 to conveniently tear the wrapper 1 for removal of the soup base and the noodles from the wrapper 1, it is difficult to tear the wrapper 1 parallel to the uneven parts 1a, therefore causing consumers inconvenience upon use of the conventional packages.

### DISCLOSURE OF THE INVENTION

Therefore, it is an object of the present invention to provide a novel concept of instant noodles, satisfying various demands of consumers.

Another object of the present invention is to provide a package for packaging a noodle or a soup base, which allows users to use all or parts of the noodles or the soup base contained in a plurality of packaging parts in the state of being separated or connected, according to likes and dislikes of individual consumers.

To achieve the above objects, the present inventors have developed a novel noodle product comprising a teabag type vegetable broth base including flakes, pellets or powders of radish juice, bean sprout juice, green tea leaves, large green onion, green chili pepper, dried fragrant mushroom, sea tangle, garlic, onion and dried pollack shreds, and an oil-free noodle infused with various flavors, which is advantageous in terms of more delicious taste, compared to conventional noodle products.

Therefore, the present invention provides a noodle product, comprising a teabag containing vegetables in the form of lyophilized flakes, powders or pellets.

Preferably, as for the noodle product, powders or pellets of radish juice, bean sprout juice, green tea leaves, large green onion, green chili pepper, dried fragrant mushroom, sea tangle, garlic, onion and dried pollack shreds are contained in the teabag.

Further, as for the noodle product, powders or pellets of green tea leaves, large green onion, green chili pepper, dried fragrant mushroom, sea tangle, garlic, onion and dried pollack shreds are contained in the teabag, and radish juice and bean sprout juice are mixed with a conventional powdered soup base to form a liquid mixture, which is then contained in an additional wrapper.

Furthermore, as for the noodle product, lyophilized flakes of green tea leaves, large green onion, green chili pepper and dried fragrant mushroom are contained in the teabag, and powders or pellets of sea tangle, garlic, onion and dried pollack shreds are contained in another teabag, and radish juice and bean sprout juice are mixed with a conventional powdered soup base to form a liquid mixture, or powders or pellets of radish juice and bean sprout juice are mixed with a conventional powdered soup base to form a solid mixture, which is then contained in an additional wrapper.

In addition, the present invention provides a method of preparing a noodle, comprising subjecting noodle materials to a series of the steps of kneading, cutting, steaming, shaping, cooling and drying, wherein potato starch in the noodle materials is used in an amount of 5-10% based on total weight of the materials, and the cut noodle is infused with a flavor at the steaming step, and the shaped noodle is directly cooled and dried without being fried.

Also, the present invention provides a noodle product comprising a teabag containing vegetables in the form of lyophilized flakes, powders or pellets, and an oil-free, flavor-infused noodle prepared by the above method.

Also, the present invention provides a package for noodle or soup base, capable of using only a desired amount of a noodle or a soup base and storing the remaining noodle or soup base by separately packaging the soup base or the noodle in a plurality of packaging parts, according to likes and dislikes of consumers.

Further, as for the package, a wrapper thereof can be conveniently torn open while contents therein are not lost.

Additionally, as for the package, the noodle-containing package is further packaged in a box type paper outer package, thereby preventing breakage thereof by external impact upon transportation and storage, and providing higher quality and more beautiful appearance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a package for noodle or soup base according to conventional techniques;

FIG. 2 is a view illustrating a package for soup base or noodle according to a primary embodiment of the present invention, in which FIG. 2A is a plan view of the package having packaging parts in the state of being connected, and FIG. 2B is a plan view of the package having packaging parts in the state of being separated;

FIG. 3 is a sectional view of the package of FIG. 2, in which FIG. 3A is a sectional view of the package having the packaging parts in the state of being connected, and FIG. 3B is a sectional view of the package having the packaging parts in the state of being separated;

FIG. 4 is a view illustrating a process of packaging the package containing noodle of the present invention into a box type paper outer package; and

FIGS. 5 to 8 are plan views illustrating packages according to other embodiments of the present invention.

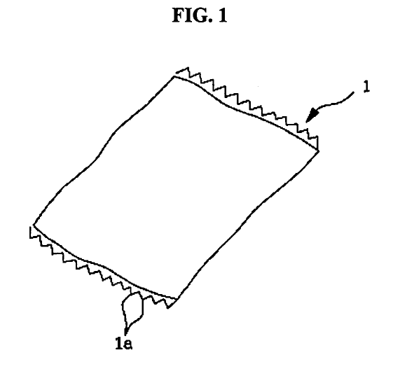

### BEST MODE FOR CARRYING OUT THE INVENTION

An instant-cooking noodle product of the present invention is different from conventional noodle products, in view of both a soup base and a noodle component.

Soup Part

Conventionally, a soup part of instant noodles includes a powdered soup base corresponding to broth and a dried flake soup base consisting of large green onion, green chili pepper, dried fragrant mushroom, sea tangle and garlic in the state of being lyophilized.

In the present invention, a vegetable broth base is further used in addition to the powdered soup base, comprising not only large green onion, green chili pepper, dried fragrant mushroom, sea tangle and garlic but also radish juice, bean sprout juice, onion, dried pollack shreds and green tea leaves.

Various materials used for formation of vegetable broth are used in the state of being packaged in a teabag. Each of radish juice, bean sprout juice, green tea leaves, large green onion, green chili pepper, dried fragrant mushroom, onion, dried pollack shreds, garlic and sea tangle used in the present invention is pelletized or powdered or lyophilized to the form of flakes, and then packaged in the teabag.

According to an aspect of the present invention, green tea leaves, onion, dried pollack shreds, garlic and sea tangle are lyophilized to flake form, mixed together and then packaged in a teabag. In addition, large green onion, green chili pepper and dried fragrant mushroom are lyophilized to flake form and used without being additionally packaged in the teabag, so that they appear as flakes in the cooked noodles, as in conventional noodles. Also, radish juice and bean sprout juice are mixed with a conventional powdered soup base to form a liquid soup base.

According to another aspect of the present invention, green tea leaves, onion, dried pollack shreds, garlic and sea tangle are lyophilized to flake form, mixed together and then packaged in a teabag. Further, large green onion, green chili pepper and dried fragrant mushroom are lyophilized to flake form and used without being additionally packaged in the teabag, so that they appear as flakes in the cooked noodles, as in conventional noodles. Also, radish juice and bean sprout juice are lyophilized and powdered or pelletized, and then mixed with a conventional powdered soup base to form a solid soup base.

According to a further aspect of the present invention, green tea leaves, onion, dried pollack shreds, garlic, sea tangle, large green onion, green chili pepper and dried fragrant mushroom are lyophilized to flake form, mixed together and then packaged in a teabag. In addition, radish juice and bean sprout juice are mixed with a conventional powdered soup base to form a liquid soup base.

According to a still further aspect of the present invention, green tea leaves, onion, dried pollack shreds, garlic, sea tangle, large green onion, green chili pepper and dried fragrant mushroom are lyophilized to flake form, mixed together and then packaged in a teabag. In addition, radish juice and bean sprout juice are lyophilized and powdered or pelletized and then mixed with a conventional powdered soup base to form a solid soup base.

According to a still further aspect of the present invention, green tea leaves, onion, dried pollack shreds, garlic and sea tangle are lyophilized and powdered or pelletized, mixed together and then packaged in a teabag. In addition, large green onion, green chili pepper and dried fragrant mushroom are processed to flake form and used without being additionally packaged in the teabag, so that they appear as the flakes in the cooked noodle as in conventional noodles. Further, radish juice and bean sprout juice are mixed with a conventional powdered soup base to form a liquid soup base.

According to a still further aspect of the present invention, green tea leaves, onion, dried pollack shreds, garlic and sea tangle are lyophilized and powdered or pelletized, mixed together and then packaged in a teabag. In addition, large green onion, green chili pepper and dried fragrant mushroom are processed to flake form and used without being additionally packaged in the teabag, so that they appear as the flakes in the cooked noodle as in conventional noodles. Further, radish juice and bean sprout juice are lyophilized and powdered or pelletized, and then mixed with a conventional powdered soup base to form a solid soup base.

According to a still further aspect of the present invention, green tea leaves, onion, dried pollack shreds, garlic, sea tangle, large green onion, green chili pepper and dried fragrant mushroom are lyophilized and powdered or pelletized, mixed together and then packaged in a teabag. Further, radish juice and bean sprout juice are mixed with a conventional powdered soup base to form a liquid soup base.

According to a still further aspect of the present invention, green tea leaves, onion, dried pollack shreds, garlic, sea tangle, large green onion, green chili pepper and dried fragrant mushroom are lyophilized and powdered or pelletized, mixed together and then packaged in a teabag. In addition, radish juice and bean sprout juice are lyophilized and powdered or pelletized, and then mixed with a conventional powdered soup base to form a solid soup base.

According to the present invention, the vegetable materials including dried pollack shreds are packaged in the teabag, which is then immersed in cold water before addition of noodles. While water is heated, light green or deep green-yellow vegetable broth is formed and the teabag is removed from water before the noodles are added to boiling water. As such, the teabag may optionally be not removed from water. The formed vegetable broth before addition of noodles provides broth of various vegetables and is light green or deep green-yellow, which is appealing to users. Moreover, because of using the teabag, vegetable residues are not seen in the cooked noodles. In addition, vegetables are selectively powdered or pelletized or processed to flake form according to consumers, thereby providing selective appearance of the vegetables. For example, since consumers including children may dislike flake ingredients seen after the instant noodle is cooked, the teabag type soup base-including instant noodle product is favorable to such consumers.

The term ‘vegetable broth’ means hot broth containing active components and flavors of various vegetables contained in the teabag, appearing light green or deep green-yellow. In the present invention, with the aim of selectively showing the vegetables, various vegetables are lyophilized and processed to flake form or powdered or pelletized to sufficiently soak active components and flavors of the vegetables.

The teabag used in the present invention may use commercially available ones. For instance, a teabag for green tea available from Dong Suh Food Co. Ltd., Korea, may be used.

The green tea leaves used in the present invention may use general green tea leaves, for example, commercially available green tea leaves in the teabag of Dong Suh Food Co. Ltd., Korea, and need not be pelletized. Addition of such green tea leaves results in green and yellow color of the soup, which is appealing to users.

As for radish juice and bean sprout juice used in the present invention, juices obtained by grinding radish or bean sprouts by use of a large mixer may be used as they are or be filtered for use. The formed radish juice and the bean sprout juice is used as a liquid phase, or lyophilized and used in the form of powders or pellets.

The other vegetables may be lyophilized and used as flakes or lyophilized and used in the form of pellets or powders, for appearance and therapeutic effects of vegetable broth. Processes of lyophilizing, pelletizing and powdering are included in the scope of general technologies, and thus do not require specific conditions for the present invention.

A soup part of the instant noodle is a very important factor for ensuring delicious noodle taste. Thus, the vegetable broth provided by the present invention is advantageous in terms of more refreshing taste, compared to conventional noodle soup consisting mainly of a powdered soup base as broth. Use of the vegetable broth comprising, based on one instant noodle serving, (or, based on 10 g of a conventional powdered soup base), 30 g of radish juice, 11 g of bean sprout juice, 7.5 g of large green onion, 8 g of green chili pepper, 0.5 g of dried fragrant mushroom, 11 g of onion, 3 g of dried pollack shreds, 4.3 g of garlic, 5.4 g of sea tangle and 1.5 g of green tea leaves, leads to the best functional results for soothing effect and delicious taste, as tested by a variety of subjects.

In addition, the amounts of radish juice, bean sprout juice, dried pollack shreds, sea tangle, and dried fragrant mushroom can be increased by up to 5 g, and the other vegetables can be used in the amount decreased or increased by about 2 g.

Noodle Part

The noodle of the present invention is completely oil-free, and further is infused with flavors. A conventional technique of preparing an instant noodle comprises subjecting noodle materials consisting mainly of flour, potato starch, wheat flour, starch acetate, purified salt, sodium L-glutamate, refined sugar and palm oil to kneading, cutting, steaming, shaping, frying, cooling and drying. As for a method of the present invention, a flavor-infusing stage is additionally introduced to the steaming step, and the frying step is excluded and thus oil is not used. In order to maintain the form of the noodle without performing the frying step, potato starch is used in the amount increased by 5-10%, compared to conventionally used amounts. In addition, the amount of the wheat flour is decreased in inverse proportion to the potato starch. At the cutting step, thickness of the noodles is increased by 10%. Also, increase of a proportion of the potato starch and thickness of the noodle at the kneading and cutting steps is required to perform the flavor-infusing stage in the steaming step.

The noodle prepared by the present invention is oil-free, and can be stored for a longer period, compared to conventional noodles. This is because conventional fried noodles smell of oil after about 1 month, and then such noodles are discolored or smell bad. Since the noodle of the present invention has high amounts of the potato starch, their texture remains good. In addition, the flavor-infused noodles may satisfy various preferences of consumers.

A better understanding of the present invention may be obtained in light of the following examples which are set forth to illustrate, but are not to be construed to limit the present invention.

### EXAMPLE 1

Radish was peeled and introduced into a greenjuicer (Dong Ah Ind. Co. Ltd., Korea), to prepare radish juice. Bean sprouts were separately introduced into the greenjuicer, to obtain bean sprout juice.

Green tea leaves, large green onion, green chili pepper, dried fragrant mushroom, onion, dried pollack shreds, garlic and sea tangle were respectively lyophilized and pelletized to a particle size of 1-2 mm by use of a pelletizer of Woong Bi Machinery Co., Korea.

Based on 10 g of a powdered soup base of commercially available Jin Ramen (Ottogi Corp., Korea), 30 g of radish juice, 11 g of bean sprout juice, 7.5 g of large green onion (hereinafter, based on pellet weight), 8 g of green chili pepper, 0.5 g of dried fragrant mushroom, 11 g of onion, 3 g of dried pollack shreds, 4.3 g of garlic, 5.4 g of sea tangle and 1.5 g of green tea leaves were used as vegetable materials.

The radish juice and the bean sprout juice were mixed with a powdered soup base to form a liquid soup base, and pellets of the other vegetable materials including dried pollack shreds were packaged in a teabag (5×4 cm, Dong Suh Food Co., Ltd., Korea).

### EXAMPLE 2

Radish juice and bean sprout juice were prepared as in the above example 1.

Large green onion, green chili pepper and dried fragrant mushroom were lyophilized and processed to flake form.

Each of green tea leaves, onion, dried pollack shreds, garlic and sea tangle was lyophilized and pelletized to a particle size of 1-2 mm by use of a pelletizer of Woong Bi Machinery Co., Korea.

Based on 10 g of a powdered soup base of commercially available Jin Ramen (Ottogi Corp., Korea), 30 g of radish juice, 11 g of bean sprout juice, 7.5 g of large green onion (hereinafter, based on pellet weight), 8 g of green chili pepper, 0.5 g of dried fragrant mushroom, 11 g of onion, 3 g of dried pollack shreds, 4.3 g of garlic, 5.4 g of sea tangle and 1.5 g of green tea leaves were used as vegetable materials.

The radish juice and the bean sprout juice were mixed with a powdered soup base to form a liquid soup base, and lyophilized flakes of large green onion, green chili pepper and dried fragrant mushroom were separately packaged, and pellets of the other vegetable materials (onion, garlic, sea tangle, green tea leaves) including dried pollack shreds were packaged in a teabag (5×4 cm, Dong Suh Food Co., Ltd., Korea).

### EXAMPLE 3

Radish juice and bean sprout juice were prepared as in the above example 1, lyophilized and powdered.

Large green onion, green chili pepper and dried fragrant mushroom were lyophilized and processed to flake form.

Each of green tea leaves, onion, dried pollack shreds, garlic and sea tangle was lyophilized and pelletized to a particle size of 1-2 mm by use of a pelletizer of Woong Bi Machinery Co., Korea.

Based on 10 g of a powdered soup base of commercially available Jin Ramen (Ottogi Corp., Korea), 30 g of radish juice, 11 g of bean sprout juice, 7.5 g of large green onion (hereinafter, based on pellet weight), 8 g of green chili pepper, 0.5 g of dried fragrant mushroom, 11 g of onion, 3 g of dried pollack shreds, 4.3 g of garlic, 5.4 g of sea tangle and 1.5 g of green tea leaves were used as vegetable materials.

Pellets of the radish juice and the bean sprout juice were mixed with a powdered soup base to form a solid soup base, and lyophilized flakes of large green onion, green chili pepper and dried fragrant mushroom were separately packaged, and pellets of the other vegetable materials (onion, garlic, sea tangle, green tea leaves) including dried pollack shreds were packaged in a teabag (5×4 cm, Dong Suh Food Co., Ltd., Korea).

### EXAMPLE 4

Radish juice and bean sprout juice were prepared as in the above example 1, lyophilized and powdered.

Large green onion, green chili pepper and dried fragrant mushroom were lyophilized and processed to flake form.

Each of green tea leaves, onion, dried pollack shreds, garlic and sea tangle was lyophilized and pelletized to a particle size of 1-2 mm by use of a pelletizer of Woong Bi Machinery Co., Korea.

Based on 10 g of a powdered soup base of commercially available Jin Ramen (Ottogi Corp., Korea), 30 g of radish juice, 11 g of bean sprout juice, 7.5 g of large green onion (hereinafter, based on pellet weight), 8 g of green chili pepper, 0.5 g of dried fragrant mushroom, 11 g of onion, 3 g of dried pollack shreds, 4.3 g of garlic, 5.4 g of sea tangle and 1.5 g of green tea leaves were used as vegetable materials.

Lyophilized flakes of large green onion, green chili pepper and dried fragrant mushroom were separately packaged, and pellets of the other vegetable materials (onion, garlic, sea tangle, green tea leaves) including dried pollack shreds were mixed with a powdered soup base, along with pellets of the radish juice and the bean sprout juice, to form a solid soup base, and packaged together in a teabag (5×4 cm, Dong Suh Food Co., Ltd., Korea).

### EXAMPLE 5

Radish juice and bean sprout juice were prepared as in the above example 1, lyophilized and powdered.

Large green onion, green chili pepper, dried fragrant mushroom, onion, dried pollack shreds, garlic, sea tangle and green tea leaves were respectively lyophilized and pelletized to a particle size of 1-2 mm by use of a pelletizer of Woong Bi Machinery Co., Korea.

Based on 10 g of a powdered soup base of commercially available Jin Ramen (Ottogi Corp., Korea), 30 g of radish juice, 11 g of bean sprout juice, 7.5 g of large green onion (hereinafter, based on pellet weight), 8 g of green chili pepper, 0.5 g of dried fragrant mushroom, 11 g of onion, 3 g of dried pollack shreds, 4.3 g of garlic, 5.4 g of sea tangle and 1.5 g of green tea leaves were used as vegetable materials.

Pellets of the above vegetable materials including dried pollack shreds, along with pellets of radish juice and bean sprout juice, were packaged together into a teabag (5×4 cm, Dong Suh Food Co., Ltd., Korea).

### EXAMPLE 6

2.4 kg of potato starch (Abebe Co. Ltd., The Netherlands), 0.8 kg of wheat flour and 6.8 kg of medium flour (Daehan Flour Corp., Korea) were mixed by use of a mixer (Sungkwang Electronic Co. Ltd., Korea) for 15 min. Then, the above mixture was uniformly admixed with 0.1 kg of refined sugar, 0.9 kg of purified salt, 0.6 kg of emulsified oil, 0.004 kg of sodium L-glutamate, 0.3 kg of starch acetate, 0.03 kg of palm oil and 1.1 kg of water for 20 min. The admixed dough was passed through a seven-stage roller to form noodle sheets, which were then longitudinally cut (diameter of 3 mm) to make noodle strands and steamed at 11° C. for about 3 min while being infused with herb flavor. The formed noodles were cut, shaped, slowly cooled at room temperature and dried, to obtain a noodle.

Experimental Example for Soup Taste

A sampling panel of instant noodle products was formed by four experienced male chefs. The results are summarized as follows.

| Noodle | Yol Ramen, Ansungtangmyun, Jin Ramen, Shin Ramyun, Snack Ramen, Jjajangparty + Shin Ramyun | |
|---|---|---|
| Brand | (hereinafter, referred to as ‘Shinjjamyun’), manufactured in Korea | |
| Tasting | 1) | Each noodle product is boiled in vegetable broth, provided that only noodle is used as a |
| Conditions | | main material, and other topping materials are completely excluded. |
| | 2) | Panelists were not informed of noodle brand. |
| | 3) | Each noodle product is boiled under the same conditions. |

| Scoring | (1) Total Combination (2) Noodle Texture (3) Soup Taste | | | | | |
|---|---|---|---|---|---|---|
| Method | Each noodle product is scored from 1 to 6 according to the above three conditions. | | | | | |
| Total | Total scored values from 1 to 6 | | | | | |
| Noodle | Shin Ramyun | Jin Ramen | Ansungtangmyun | Yol | Snack Ramen | Shinjjamyun |
| Texture | | | | Ramen | | |
| | 20 | 15 | 15 | 13 | 13 | 8 |
| Soup Taste | Ansungtangmyun | Jin Ramen | Shin Ramyun | Yol | Shinjjamyun | Snack Ramen |
| | | | | Ramen | | |
| | 18 | 16 | 16 | 15 | 13 | 6 |
| Combination | Ansungtangmyun | Shin Ramyun | Jin Ramen | Yol | Shinjjamyun | Snack Ramen |
| | | | | Ramen | | |
| | 18 | 17 | 15 | 14 | 13 | 7 |
| Sum Result | Shin Ramyun | Ansungtangmyun | Jin Ramen | Yol | Shinjjamyun | Snack Ramen |
| | | | | Ramen | | |
| | 53 | 51 | 46 | 42 | 34 | 26 |

| | |
|---|---|
| Analysis | As results of a blind investigation, Shin Ramyun, Ansungtangmyun and Jin Ramen were favorites, |
| | in order, which correspond to market share at present. |
| | Jin Ramen is second in the tests, exclusive of the combination test. |
| | For accuracy, the above experiment was repeated two times at different times. |

| Noodle Brand | Shin Ramyun, Ansungtangmyun, Jin Ramen (Spicy) | |
|---|---|---|
| Tasting Conditions | 1) | Shin Ramyun and Ansungtangmyun are boiled in purified water. |
| | 2) | Jin Ramen (Spicy) is boiled with the soup base of the above example 1. |
| | 3) | Panelists were not informed of noodle brand. |
| | 4) | Each noodle product is boiled under the same conditions, exclusive of water |

| Scoring/Total | The same as mentioned above | | |
|---|---|---|---|
| Noodle Texture | Shin Ramyun | Jin Ramen | Ansungtangmyun |
| | 10 | 7 | 7 |
| Soup Taste | Jin Ramen | Shin Ramyun | Ansungtangmyun |
| | 11 | 8 | 5 |
| Combination | Jin Ramen | Shin Ramyun | Ansungtangmyun |
| | 11 | 7 | 6 |
| Sum Result | Jin Ramen | Shin Ramyun | Ansungtangmyun |
| | 29 | 25 | 18 |

| | |
|---|---|
| Analysis | Ranking of the noodle products is different from the first test, exclusive of the noodle |
| | texture. |
| | The above experiment was repeated, but ranking was not changed. From this, it can |
| | be found that, when conventional spicy flavorings of Jin Ramen are mixed with |
| | vegetable broth, the flavor is improved relative to other brands of noodles. |

Consequently, it can be seen that the soup base of the present invention functions to improve tastes of the commercial instant noodles.

Package for Soup Base and Noodle

1. Package for Soup Base

In order to solve problems of conventional packages for soup bases, a package of the present invention has a dividing part to separately contain the soup base in a plurality of spaces. Upon tearing a wrapper of the package, vertical tearing of the package relative to the dividing part enables addition of the entire soup base. On the other hand, parallel tearing of the package relative to the dividing part enables addition of only parts of the soup base.

Thus, as for the package of the soup base in the form of powder, liquid or flake, the dividing part is formed at a predetermined portion of the wrapper of the package, whereby the soup base is separately contained in at least two packaging parts.

In addition, a tearing part is formed at one end of the wrapper to cross the packaging parts of the wrapper.

Preferably, the dividing part is formed with cleavage parts at both sides of a sealing part thereof to divide both packaging parts at the sealing part.

The wrapper is formed in a circular shape. Further, the wrapper may be formed in triangular, rectangular and polygonal shapes.

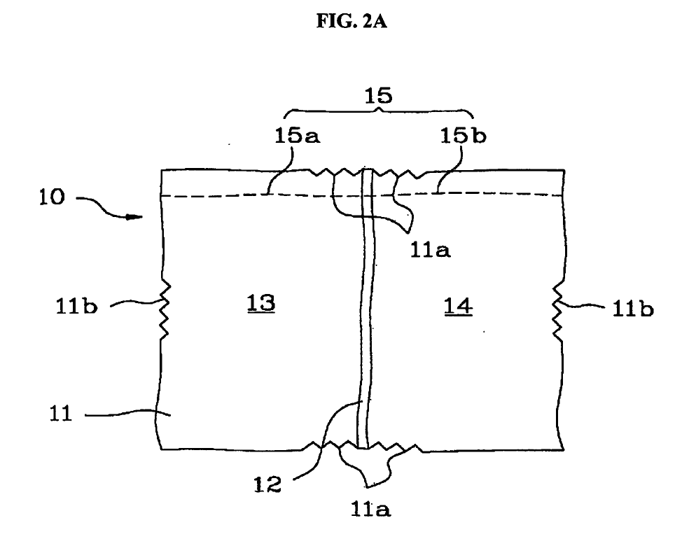

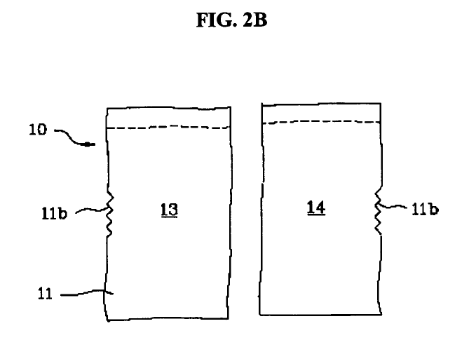

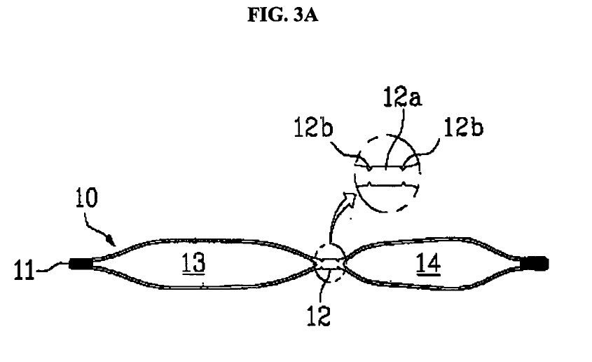

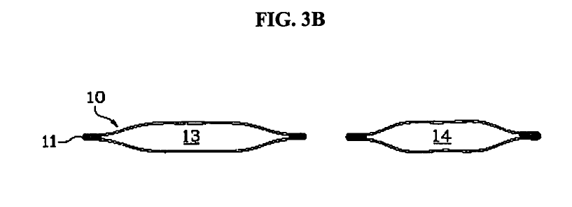

With reference to FIG. 2, a package for soup base according to a primary embodiment of the present invention is shown. As shown in FIG. 2, a wrapper 11 of the package 10 is divided into two portions by a dividing part 12 formed at a central portion thereof. Thereby, a first packaging part 13 and a second packaging part 14 are separately formed and a tearing part 15 is formed at one end of the wrapper 11.

The dividing part 12 formed at the central portion of the wrapper 11 is subjected to a sealing treatment to section the first packaging part 13 and the second packaging part 14, in which cleavage parts 12b are formed at both sides of a sealing part 12a so as to easily divide the first packaging part 13 and the second packaging part 14 centering the sealing part 12a.

The tearing part 15 formed at one end of the wrapper 11 includes a first tearing part 15a formed at a terminal portion of the first packaging part 13 and a second tearing part 15b formed at a terminal portion of the second packaging part 14.

Each of middle portions of four ends of the wrapper 11 is formed with an uneven part. The wrapper 11 is torn parallel to the dividing part 12 by uneven parts 11a formed at both sides of the dividing part 12. Thereby, either of the first packaging part 13 or the second packaging part 14 may be torn. On the other hand, by other uneven parts 11b formed at side ends of each of the first and second packaging parts 13 and 14, the wrapper 11 is vertically torn to the dividing part 12, thereby opening all the first and second packaging parts 13 and 14.

Upon tearing the package 10 according to the primary embodiment of the present invention, when all soup contents contained in the package 10 are used by a consumer liking spicy foods, the first tearing part 15a and the second tearing part 15b of the tearing part 15 formed at one end of the wrapper 11 are completely torn. That is, while one side of the first tearing part 15a is pulled, the second tearing part 15b is continuously pulled in the state of the first tearing part 15a reaching the dividing part 12, whereby the tearing part 15 is completely torn and the soup contents are totally removed from the wrapper 11.

Meanwhile, in case of disliking spicy foods, one cleavage part 12b is torn in the state of the first tearing part 15a being torn, and thus the first packaging part 13 is separated from the second packaging part 14. Otherwise, cleavage parts 12b of each of the first packaging part 13 and the second packaging part 14 are torn, and thus the first packaging part 13 is separated from the second packaging part 14, after which the tearing part 15a or 15b of either of the first packaging part 13 or the second packaging part 14 is torn. Thereby, the soup contents in the opened packaging part are added to the noodles, and the other packaging part is stored in the state of being not opened.

Although the dividing part 12 of the wrapper 11 of the package 10 according to the primary embodiment is formed at a central portion thereof, it may be formed at a position offset from the center of the wrapper 11, thus varying amounts of the soup base according to likes and dislikes of consumers.

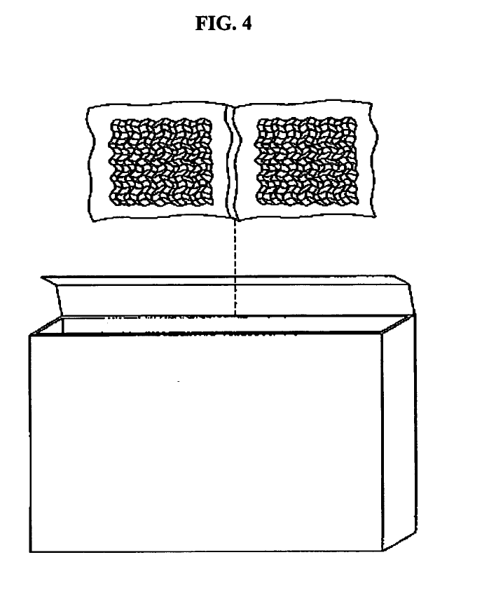

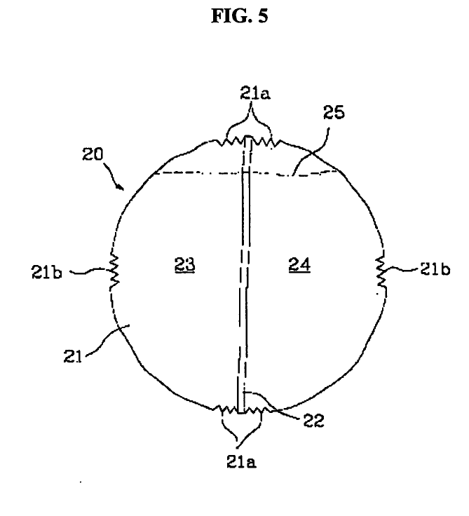

According to a second embodiment of the present invention, a wrapper 21 of a package 20 is formed in a circular shape, in which a dividing part 22 is formed at a central portion thereof, as shown in FIG. 5. Thereby, a first packaging part 23 and a second packaging part 24 are sectioned. A tearing part 25 is formed at one side of the circular wrapper 21. At both sides of the dividing part 22, uneven parts 21a are formed, and other uneven parts 21b are formed at side ends of the first and second packaging parts 23 and 24.

The package 20 according to the second embodiment of the present invention provides a more attractive appearance, compared to rectangular packages, and impresses a consumer favorably. In addition, the tearing part 25 is relatively short and the wrapper 21 may be simply torn. Such a tearing process of the wrapper 21 is the same in the first embodiment and description therefor is omitted.

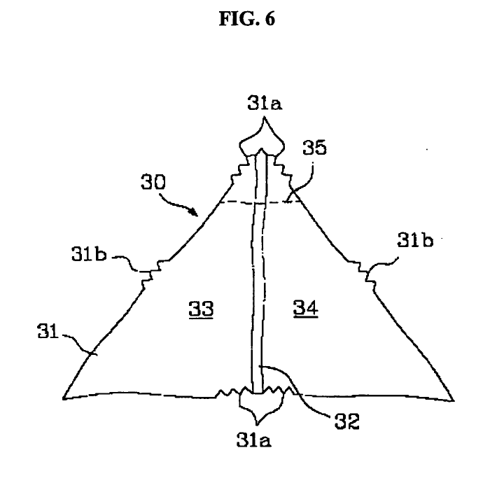

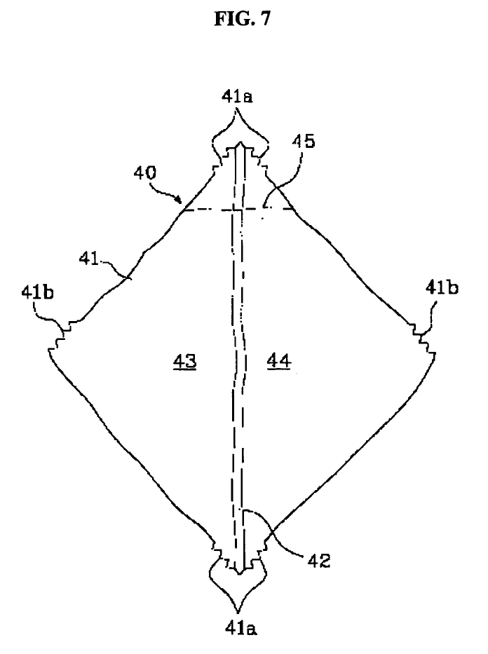

In addition, the package according to the second embodiment may be variously shaped. As shown in FIG. 6, a wrapper 31 of a package 30 is formed in a triangular shape, in which a dividing part 32 is formed at a central portion thereof. Both sides of the dividing part 32 are sectioned to a first packaging part 33 and a second packaging part 34. A tearing part 35 is formed at an apex portion of the wrapper 31. Further, a wrapper 41 of a package 40 may be formed in a diamond shape as shown in FIG. 7. A dividing part 42 is formed at a central portion of the wrapper 41, whereby a first packaging part 43 and a second packaging part 44 are separately formed, and a tearing part 45 is formed at a corner portion of the wrapper 41. Although not shown in the drawing, a polygonal shaped package may be used. The reference numerals 31a, 31b, 41a and 41b indicate uneven parts.

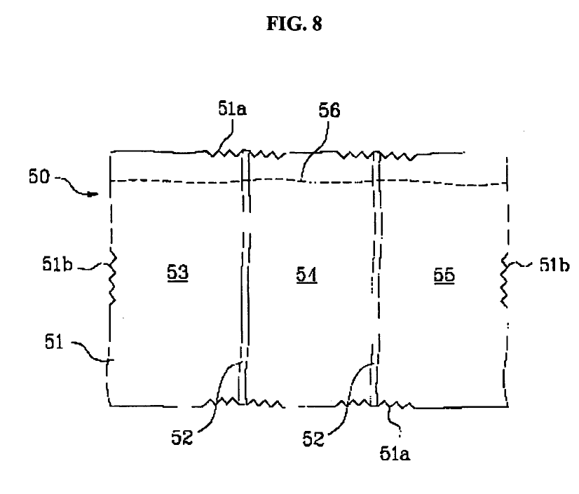

As seen in FIG. 8, a package 50 according to a third embodiment of the present invention includes three or more packaging parts 53, 54, 55 divided by at least two dividing parts 52 (two in FIG. 8) of a wrapper 51, to meet various demands of consumers.

The dividing parts 52 are formed at regular or irregular intervals, so that at least two types of noodles are simultaneously cooked, or consumers not liking spicy foods can vary the amount of the soup base. Thereby, amounts of soup bases contained in each packaging part 53, 54, 55 may be different. The reference numerals 51a and 51b indicate uneven parts, and the numeral 56 indicates a tearing part.

In the above embodiments, the soup base is in the form of powder, liquid or flake unless otherwise indicated.

2. Package for Noodle

The present invention provides a package enabling a user to cook only a desired amount of noodles and store the remaining noodles, by forming a plurality of noodle-packaging parts, according to likes and dislikes of consumers.

In addition, the present invention provides a double package comprising a noodle-containing package and a box type paper outer package, which looks good and is advantageous in terms of prevention of breakage of the package by external impact upon transportation and storage thereof.

The package for noodles according to the present invention has essentially the same structure as the package for soup base, except that it is very different in size, strength, etc., from those of the package for soup base, thus having a large package size. As necessary, the package for noodles may be changed as in various embodiments of the package for soup base. In the package for soup base, since a plurality of packaging parts may be vertically torn relative to a dividing part at one time, the total soup contents are used for cooking. However, the entire package for noodles may be not completely torn at one time.

That is, as for the package for noodles, a plurality of packaging parts of the noodles are in the state of being connected or being separated, whereby an amount of the noodles can be controlled as desired (FIGS. 2 & 3).

Hence, the present invention provides a package for noodles characterized in that noodles are separately contained in at least two packaging parts sectioned by a dividing part formed at a predetermined portion of a wrapper of the package.

In addition, the present invention provides a package for noodles characterized in that noodles are separately contained in at least two packaging parts in the state of being previously torn while a dividing part is not formed at a predetermined portion of a wrapper of the package.

Moreover, the present invention provides a double package comprising a noodle-containing package and a box type paper outer package enclosing the noodle-containing package.

As for a package 10 according to a primary embodiment of the present invention shown in FIG. 2A, a dividing part 12, functioning to section a wrapper 11 of the package 10 into two portions, is formed at a central portion of the wrapper 11, thus obtaining a first packaging part 13 and a second packaging part 14. In addition, a tearing part 15 is formed at one end of the wrapper 11.

A package having separate first and second packaging parts shown in FIG. 2B is the same as one shown in FIG. 2A, except that there is no dividing part 12. Hereinafter, the package having the packaging parts in the state of being connected is described.

The dividing part 12 formed at a central portion of the wrapper 11 is subjected to a sealing treatment, so as to section the first packaging part 13 and the second part 14. In the dividing part 12, cleavage parts 12b are formed at both sides of a sealing part 12a to easily divide the first packaging part 13 and the second packaging part 14 at the sealing part 12a.

A tearing part 15 formed at one end of the wrapper 11 includes a first tearing part 15a formed at a terminal portion of the first packaging part 13 and a second tearing part 15b formed at a terminal portion of the second packaging part 14.

Each of middle portions of the four sides of the wrapper 11 is formed with an uneven part, in which the wrapper 11 can be torn parallel to the dividing part 12 by uneven parts 11a formed at both sides of the dividing part 12, thereby opening either of the first packaging part 13 or the second part 14. Further, the wrapper 11 can be vertically torn to the dividing part 12 by other uneven parts 11b formed at respective side ends of the first packaging part 13 and the second part 14.

Upon tearing the package 10 according to the primary embodiment, if a consumer wants to cook all the noodle contents contained in the package 10, the first and second tearing parts 15a and 15b of the tearing part 15 formed at one end of the wrapper 11 having separated or connected packaging parts are torn, or other uneven parts 11b formed at side ends of the first and second packaging parts 13 and 14 are torn completely.

On the other hand, for consumers having small appetites, one cleavage part 12b is torn in the state of the first tearing part 15a being torn, and thus the first packaging part 13 is separated from the second packaging part 14. Or, cleavage parts 12b of each of the first and second packaging parts 13 and 14 are torn and thus the first packaging part 13 is separated from the second packaging part 14. Thereafter, the tearing part 15a or 15b of either of the first packaging part 13 or the second packaging part 14 is torn and only the corresponding noodles may be cooked, and the remaining noodles are stored in the state of being contained in the unopened packaging part.

As for the package for noodles having the separated packaging parts, the uneven parts formed at each side of the wrapper are torn and the contents therein are used.

The dividing part 12 is variously positioned as in the package for soup base, according to likes and dislikes of consumers. As for the package having separated packaging parts, the uneven parts may be formed at various positions.

In addition, the package of the present invention may be formed in various shapes, such as a circle, triangle, etc., as necessary. The packaging parts of the noodle are formed to at least two, as necessary, and are the same or different in their size and shape. Thereby, the amount of the noodles contained in each of the packaging parts is variable, depending on various demands of consumers. In the case of the separated packaging parts, they may formed to various sizes.

In the package for noodles having connected or separated packaging parts, noodles are packaged according to general methods. In the present invention, vacuum packaging is preferable in terms of preventing packages for noodles from breaking under external impact during transporting and storing, and preventing noodle contents from deteriorating over time, for example, rotting. Therefore, the noodle contained the package of the present invention is storable for long periods.

The noodles are contained in different amounts into the packaging parts of the package, generally 60-100 g, preferably 70-80 g, according to demands of consumers. In the present invention, based on two packaging parts, 75 g each is preferable.

As necessary, the soup base may be packaged in the packaging parts of the noodle together with the noodle, or separately packaged.

The package for noodles of the present invention is further packaged in a box type paper outer package, compared to conventional single packages. The above box type package is generally made of paper, and has various sizes, for example, 10-15 cm×10-15 cm with a height of 3-5 cm. It is preferable that the size of the box type package is 3.5×14×14 cm.

Conventional single packages suffer from easy breakage by external impact upon transportation and storage thereof, and appear cheap due to appearance of the package. Meanwhile, the double package of the present invention having the box type paper outer package is advantageous in terms of high quality, beautiful appearance, and prevention of breakage of products.

The present invention has been described in an illustrative manner, and it should be understood that the terminology used is intended to be in the nature of description rather than of limitations. Many modifications and variations of the present invention are possible in light of the above teachings. Therefore, it should be understood that within the scope of the appended claims, the invention may be practiced otherwise than as specifically described.

1. (canceled)

2. A noodle product, comprising a teabag containing powders or pellets of vegetables comprising radish juice, bean sprout juice, green tea leaves, large green onion, green chili pepper, dried fragrant mushroom, sea tangle, garlic, onion, and dried pollack shreds.

3. A noodle product, comprising a teabag containing powders or pellets of vegetables comprising green tea leaves, a large green onion, green chili pepper, dried fragrant mushroom, sea tangle, garlic, onion, and dried pollack shreds, wherein radish juice and bean sprout juice are mixed with a conventional powdered soup base to form a liquid mixture, which is then contained in an additional wrapper.

4. A noodle product, comprising a teabag containing powders or pellets of flakes comprising lyophilized large green onion, green chili pepper and dried fragrant mushroom, and vegetables comprising green tea leaves, sea tangle, garlic, onion, and dried pollack shreds, wherein radish juice and bean sprout juice are mixed with a conventional powdered soup base to form a liquid mixture, or powders or pellets of radish juice and bean sprout juice are mixed with a conventional powdered soup base to form a solid mixture, which is then contained in an additional wrapper.

5. A noodle product, comprising a teabag containing flakes comprising lyophilized green tea leaves, a large green onion, green chili pepper and dried fragrant mushroom and another teabag containing powders or pellets of vegetables comprising sea tangle, garlic, onion and dried pollack shreds,
wherein radish juice and bean sprout juice are mixed with a conventional powdered soup base to form a liquid mixture, or powders or pellets of radish juice and bean sprout juice are mixed with a conventional powdered soup base to form a solid mixture, which is then contained in an additional wrapper.

6. A noodle product as defined in claim 2, comprising 30 g of radish juice, 11 g of bean sprout juice, 7.5 g of large green onion, 8 g of green chili pepper, 0.5 g of dried fragrant mushroom, 11 g of onion, 3 g of dried pollack shreds, 4.3 g of garlic, 5.4 g of sea tangle and 1.5 g of green tea leaves, based on 10 g of a conventional powdered soup base.

7. A method of preparing a noodle, comprising subjecting noodle materials to a series of the steps of kneading, cutting, steaming, shaping, cooling and drying, wherein potato starch in the noodle materials is used in an amount of 5-10% based on total weight of the materials, and the cut noodle is infused with a flavor at the steaming step, and the shaped noodle is directly cooled and dried without being fried.

8. The method as defined in claim 7, wherein the flavor is an aromatic material.

9. A noodle product, comprising a teabag containing vegetables in the form of lyophilized flakes, powders or pellets, and an oil-free, flavor-infused noodle prepared by the method of claim 7.

10. A package comprising a wrapper containing a soup base or a noodle, wherein a dividing part is formed at a predetermined portion of the wrapper, and the soup base or the noodle is separately contained in at least two packaging parts.

11. The package as defined in claim 10, wherein a tearing part is formed at one end of the wrapper to cross the packaging parts of the wrapper.

12. The package as defined in claim 10, wherein uneven parts are formed at both sides of the dividing part to tear the wrapper parallel to the dividing part of the wrapper, and other uneven parts are formed at the side ends of the packaging parts to vertically tear the wrapper relative to the dividing part of the wrapper.

13. The package as defined in claim 10, wherein the dividing part is formed with cleavage parts at both sides of a sealing part thereof to separate both packaging parts centering the sealing part.

14. The package as defined in claim 10, wherein the wrapper is formed in a circular shape.

15. The package as defined in claim 10, wherein the wrapper is formed in a rectangular shape.

16. The package as defined in claim 10, wherein each of the packaging parts is separately openable.

17. A noodle product as defined in claim 3, comprising 30 g of radish juice, 11 g of bean sprout juice, 7.5 g of large green onion, 8 g of green chili pepper, 0.5 g of dried fragrant mushroom, 11 g of onion, 3 g of dried pollack shreds, 4.3 g of garlic, 5.4 g of sea tangle and 1.5 g of green tea leaves, based on 10 g of a conventional powdered soup base.

18. A noodle product as defined in claim 4, comprising 30 g of radish juice, 11 g of bean sprout juice, 7.5 g of large green onion, 8 g of green chili pepper, 0.5 g of dried fragrant mushroom, 11 g of onion, 3 g of dried pollack shreds, 4.3 g of garlic, 5.4 g of sea tangle and 1.5 g of green tea leaves, based on 10 g of a conventional powdered soup base.

19. A noodle product as defined in claim 5, comprising 30 g of radish juice, 11 g of bean sprout juice, 7.5 g of large green onion, 8 g of green chili pepper, 0.5 g of dried fragrant mushroom, 11 g of onion, 3 g of dried pollack shreds, 4.3 g of garlic, 5.4 g of sea tangle and 1.5 g of green tea leaves, based on 10 g of a conventional powdered soup base.

20. The package as defined in claim 11, wherein uneven parts are formed at both sides of the dividing part to tear the wrapper parallel to the dividing part of the wrapper, and other uneven parts are formed at the side ends of the packaging parts to vertically tear the wrapper relative to the dividing part of the wrapper.
